(19) United States
(12) Patent Application Publication
(10) Pub. No.: US 2021/0204350 A1
(43) Pub. Date: Jul. 1, 2021

(54) Wireless Communication Method and Device

(71) Applicant: GUANGDONG OPPO MOBILE TELECOMMUNICATIONS CORP., LTD., Dongguan (CN)

(72) Inventors: Qianxi Lu, Dongguan (CN); Zhenshan Zhao, Dongguan (CN); Huei-Ming Lin, South Yarra (AU)

(21) Appl. No.: 17/201,959

(22) Filed: Mar. 15, 2021

Related U.S. Application Data
(63) Continuation of application No. PCT/CN2018/108376, filed on Sep. 28, 2018.

(51) Int. Cl. H04W 76/25; H04W 76/30; H04W 8/24

(52) U.S. Cl. CPC H04W 76/25; H04W 92/18; H04W 8/24; H04W 76/30

(57) ABSTRACT

Provided in the implementations of the present disclosure are a wireless communication method and device. The method comprises: a first terminal device sending a first message to a second terminal device, wherein the first message is used to indicate at least one radio access technique (RAT), and the at least one RAT is a RAT requested by the first terminal device for connection management and/or a RAT supported by the first terminal device.

### CROSS-REFERENCE TO RELATED APPLICATION(S)

This application is a continuation application of International PCT Application No. PCT/CN2018/108376 filed on Sep. 28, 2018, the entire content of which is hereby incorporated by reference.

### TECHNICAL FIELD

Implementations of the present disclosure relate to a field of communications, and more particularly, to a wireless communication method and device.

### BACKGROUND

Internet of vehicles (IOV) system is Sidelink (SL) transmission technology based on Long Term Evaluation Vehicle to Vehicle (LTE V2V). Different from a way that communication data are received or sent through a base station in a traditional LTE system, the IOV system adopts a direct communication mode of terminal-to-terminal. Thus the IOV system has a higher spectral efficiency and a lower transmission delay.

In the IOV system, connection managements such as a connection establishment and a connection release may be performed between terminal devices, and communication between the terminal devices may be achieved through the connection management. For terminal devices supporting different radio access technologies (RAT), how to perform the connection management between terminal devices has become an urgent problem to be solved.

### SUMMARY

Implementations of the invention provide a method and a device for a wireless communication.

In a first aspect, there is provided a wireless communication method, including: sending, by a first terminal device, a first message to a second terminal device, wherein the first message is used for indicating at least one radio access technology RAT, and the at least one RAT is a RAT for performing a connection management requested by the first terminal device and/or a RAT supported by the first terminal device.

In a second aspect, there is provided a wireless communication method, including: receiving, by a second terminal device, a first message sent by a first terminal device, wherein the first message is used for indicating at least one radio access technology RAT, and the at least one RAT is a RAT used by the first terminal device to request performing a connection management and/or a RAT supported by the first terminal device.

In a third aspect, there is provided a first terminal device, configured to execute a method in the above first aspect or various implementations of the first aspect.

Specifically, the first terminal device includes functional modules for executing the method in the above first aspect or various implementations of the first aspect.

In a fourth aspect, there is provided a second terminal device, configured to perform a method in the second aspect or various implementations of the second aspect described above.

Specifically, the second terminal device includes function modules for executing the method in the above second aspect or in various implementations of the second aspect.

In a fifth aspect, there is provided a communication device, configured to perform the methods in the above first to second aspects.

Specifically, the communication device includes a functional module for executing the methods in the above first to second aspects.

In a sixth aspect, there is provided a terminal device, including a processor and a memory. The memory is configured to store a computer program, and the processor is configured to call and run the computer program stored in the memory to execute methods in the above first to second aspects.

In a seventh aspect, there is provided a chip, for implementing methods in the above first to second aspects.

Specifically, the chip includes a processor configured to call and run a computer program from a memory and cause a device provided with the chip to execute methods in the above first to second aspects.

In an eighth aspect, there is provided a computer-readable storage medium for storing a computer program that causes a computer to execute methods in the above first to second aspects.

In a ninth aspect, there is provided a computer program product including computer program instructions that cause a computer to execute methods in the above first to second aspects.

In a tenth aspect, there is provided a computer program, when run on a computer, the computer is caused to execute methods in above first to second aspects.

### BRIEF DESCRIPTION OF DRAWINGS

FIG. 1 is a schematic diagram of a communication mode of Internet of vehicles (IOV) provided by an implementation of the present disclosure.

FIG. 2 is a schematic diagram of another communication mode of Internet of vehicles (IOV) provided by an implementation of the present disclosure.

FIG. 3 is a schematic flow chart of a wireless communication method provided by an implementation of the present disclosure.

FIG. 4 is a schematic block diagram of a first terminal device provided by an implementation of the present disclosure.

FIG. 5 is a schematic block diagram of a second terminal device provided by an implementation of the present disclosure.

FIG. 6 is a schematic block diagram of a communication device provided by an implementation of the present disclosure.

FIG. 7 is a schematic block diagram of a chip provided by an implementation of the present disclosure.

FIG. 8 is a schematic block diagram of a communication system provided by an implementation of the present disclosure.

### DETAILED DESCRIPTION

Technical solutions in implementations of the present disclosure are described below with reference to the accompanying drawings.

Implementations of the present invention may be applied to any communication architecture of terminal device to terminal device.

For example, Vehicle to Vehicle (V2V), Vehicle to Everything (V2X), Device to Device (D2D), etc.

Terminals in implementations of the present disclosure may be any device or apparatus configured with a physical layer and a media access control layer. The terminal device may be called an access terminal, such as a user equipment (UE), a user unit, a user station, a mobile station, a mobile site, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device or other linear processing devices connected to a wireless modem, a vehicle-mounted device, a wearable device, etc. Implementations of the present invention are described by taking a vehicle-mounted device as an example, but are not limited thereto.

Optionally, in implementations of the present invention, implementations of the present invention may be applicable to transmission mode 3 and transmission mode 4 defined in Rel-14 of a 3rd generation partnership project (3GPP).

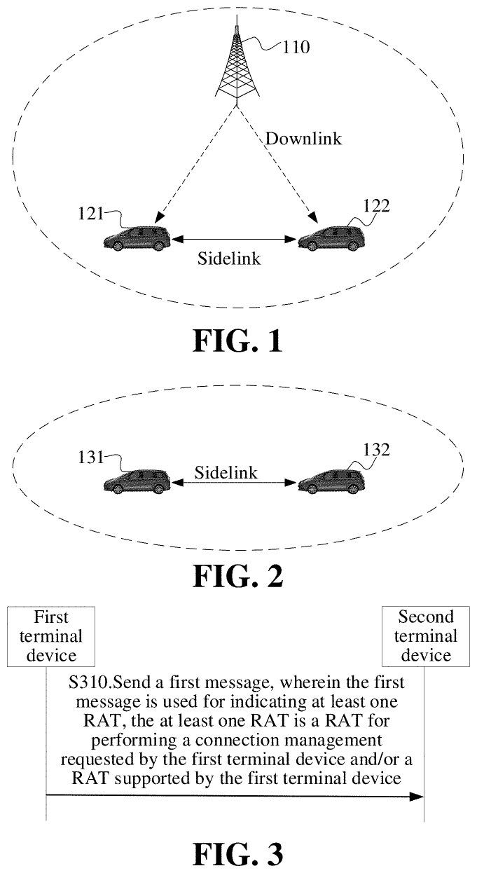

FIG. 1 is a schematic diagram of transmission mode 3 of implementations of the present disclosure. FIG. 2 is a schematic diagram of transmission mode 4 of implementations of the present disclosure.

In transmission mode 3 as shown in FIG. 1, transmission resources of a vehicle-mounted terminal (a vehicle-mounted terminal 121 and a vehicle-mounted terminal 122) are allocated by a base station 110, and the vehicle-mounted terminal performs a data transmission on a sidelink according to the resources allocated by the base station 110. Specifically, the base station 110 may allocate resources for a single transmission or a semi-static transmission to the terminal.

In transmission mode 4 as shown in FIG. 2, the vehicle-mounted terminal (a vehicle-mounted terminal 131 and a vehicle-mounted terminal 132) adopts a transmission mode of sensing and reservation, and the vehicle-mounted terminal independently selects transmission resources from resources of the sidelink for a data transmission.

The vehicle-mounted terminal 131 will be described in detail as an example below.

The vehicle-mounted terminal 131 obtains a set of available transmission resources in a resource pool by a mode of sensing, and the vehicle-mounted terminal 131 randomly selects a resource from the set for a data transmission.

Since services in an Internet of vehicles system have periodic characteristics, in implementations of the present disclosure, the vehicle-mounted terminal 131 may also adopt a mode of a semi-static transmission. That is, after taking a transmission resource, the vehicle-mounted terminal 131 continuously uses the resource in multiple transmission cycles to reduce a probability of a resource reselection and a resource conflict.

The vehicle-mounted terminal 131 may carry information of a resource reserved for a next transmission in control information of a current transmission, so that other terminals (for example, the vehicle-mounted terminal 132) may determine whether the resource is reserved and used by a user by detecting control information of the user, thus achieving a purpose of reducing resource conflicts.

The technical solutions of implementations of the present disclosure may be applied to various communication systems, such as a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, a LTE Frequency Division Duplex (FDD) system, a LTE Time Division Duplex (TDD), a Universal Mobile Telecommunication System (UMTS), a Worldwide Interoperability for Microwave Access (WiMAX) communication system, or a 5G system, etc.

A term “terminal device” in implementations of the present disclosure, includes, but not limited to, an apparatus configured to receive/send a communication signal, connected via a wired line, for example, via a Public Switched Telephone Network (PSTN), a Digital Subscriber Line (DSL), a digital cable, a direct cable; and/or another data connection/network; and/or via a wireless interface, for example, for a cellular network, a Wireless Local Area Network (WLAN), a digital television network such as a DVB-H network, a satellite network, and an AM-FM broadcast transmitter; and/or another terminal device; and/or an Internet of Things (IoT) device. A terminal device configured to communicate via a wireless interface may be referred to as a “wireless communication terminal”, a “wireless terminal” or a “mobile terminal”. Examples of the mobile terminal include, but not limited to, a satellite or cellular telephone, a Personal Communication System (PCS) terminal that can be combined a cellular wireless telephone and data processing, faxing, and data communication abilities, a PDA that may include a radio telephone, a pager, an internet/intranet access, a Web browser, a memo pad, a calendar, and/or a Global Positioning System (GPS) receiver, and a conventional laptop and/or palmtop receiver or other electronic apparatuses including a radio telephone transceiver.

The terminal device may be referred to as an access terminal, a user equipment (UE), a user unit, a user station, a mobile station, a mobile site, a remote station, a remote terminal, a mobile device, a user terminal, a terminal, a wireless communication device, a user agent, or a user apparatus. The access terminal may be a cellular phone, a cordless phone, a Session Initiation Protocol (SIP) phone, a Wireless Local Loop (WLL) station, a Personal Digital Assistant (PDA), a handheld device with a wireless communication function, a computing device or other processing devices connected to a wireless modem, a vehicle-mounted device, a wearable device, a terminal device in a 5G network, or a terminal device in a future evolved PLMN (Public Land Mobile Network), etc.

Optionally, a 5G system or a 5G network may be referred to as a New Radio (NR) system or a NR network.

It should be understood that terms “system” and “network” are often used interchangeably in this document. A term “and/or” in this document is merely an association relationship describing associated objects, indicating that there may be three relationships. For example, A and/or B may indicate three cases: A alone, A and B, and B alone. In addition, a symbol “/” in this document generally indicates that objects before and after the symbol “/” have an “or” relationship.

Technical solutions in implementations of the present disclosure will be described below with reference to the drawings in implementations of the present disclosure. It is apparent that implementations described are just some implementations of the present disclosure, but not all implementations of the present disclosure. Based on implementations of the present disclosure, all other implementations achieved by a person of ordinary skill in the art without paying an inventive effort are within a protection scope of the present disclosure.

In an Internet of vehicles system, a connection management may be performed between terminal devices. For example, a connection establishment, a connection keep-alive, a connection reconfiguration or a connection release may be performed between terminal devices. Through the connection managements, the terminal devices may perform an effective communication with the terminal devices.

The connection establishment may be used to establish a connection between two terminal devices, so that a communication may be performed. The connection keep-alive may be used to maintain a connection state between two terminal devices, a connection reconfiguration may be used to modify a current connection between terminal devices, and a connection release may be used to disconnect the current connection between terminal devices.

Taking establishing a connection as an example, the first terminal device may establish a connection with the second terminal device in order to communicate with the second terminal device. The first terminal device may send a first message to the second terminal device, wherein the first message is used for requesting to perform a connection establishment, so that the second terminal device may establish a connection with the first terminal device based on the first message.

At present, the terminal device may support two communication modes, an LTE-based communication and an NR-based communication. How to perform a connection management for the two communication modes is an urgent problem to be solved.

Implementations of the present disclosure provide a wireless communication method, which may be used for determining a corresponding RAT used by a terminal device to perform a connection management.

As shown in FIG. 3, a wireless communication method provided by implementations of the application includes step 310.

In step 310, a first terminal device sends a first message to a second terminal device, wherein the first message is used for indicating at least one RAT, the at least one RAT is a RAT for performing a connection management requested by the first terminal device and/or a RAT supported by the first terminal device.

Sending the first message by the first terminal device to the second terminal device may be understood as sending the first message by the first terminal device to the second terminal device in a D2D mode, sending the first message by the first terminal device to the second terminal device in V2X mode, or sending the first message by the first terminal device to the second terminal device through a sidelink.

The connection management may be, for example, a connection establishment, a connection keep-alive, a connection reconfiguration or a connection release, etc.

Optionally, the connection management between the first terminal device and the second terminal device may be performed in a unicast manner, or in a multicast or broadcast manner, which is not specifically limited in implementations of the present disclosure.

The first message may be a connection management request message. For example, the first message may be a connection establishment request message, a connection keep-alive request message, a connection reconfiguration request message or a connection release request message.

The first message may be understood as a signaling through which the second terminal device performs a connection management with the first terminal device.

The terminal device may support two communication modes. The corresponding RAT used by a terminal device to perform the connection management may be, for example, a RAT corresponding to LTE, a RAT corresponding to NR, or a RAT corresponding to both LTE and NR.

RAT may also be understood as a network type.

For convenience of a description, implementations of the present disclosure represent two RATs supported by the terminal device as a first RAT and a second RAT.

Implementations of the present disclosure only take that the terminal device may possibly support two communication modes as an example. The terminal device may alternatively possibly support more than two communication modes, which is not specifically limited by implementations of the present disclosure. Supporting more than two communication modes is also suitable for technical solutions provided by implementations of the present disclosure.

Taking that the terminal devices support two communication modes as an example, the first message sent by the first terminal device may be used for indicating a RAT used by the first terminal device to request for performing the connection management. For example, the connection management requested by the first terminal device to establish may be the first RAT and/or the second RAT. The second terminal device may establish a connection management with the first terminal device according to the RAT for performing the connection management requested by the first terminal device.

Optionally, the first terminal device may send a message to request to establish a connection management corresponding to multiple RATs, or send multiple messages to request to establish a connection management corresponding to multiple RATs.

For example, the first terminal device may send a first message to request to establish a connection management corresponding to the first RAT and send a second message to request to establish a connection management corresponding to the second RAT.

For another example, the first terminal device may send a first message to request to establish a connection management corresponding to the first RAT and a connection management corresponding to the second RAT.

There are many ways for the first terminal device to indicate a RAT for requesting to perform a connection management through the first message. The first terminal device may directly carry information of the RAT for requesting to perform a connection management in the first message, or the first terminal device may implicitly indicate the RAT for requesting to perform a connection management through other information.

For example, the first terminal device may carry information of at least one RAT in the first message to indicate the RAT for requesting to perform the connection management.

When the first terminal device carries information of the first RAT in the first message, it may indicate that the first terminal device wants to perform a connection management corresponding to the first RAT. The second terminal device may perform a connection management with the first terminal device according to a situation of RATs supported by itself. When the second terminal device also supports a connection management for the first RAT, the second terminal device may establish a connection management corresponding to the first RAT with the first terminal device according to the first message.

When the first terminal device carries information of the second RAT in the first message, it may indicate that the first terminal device wants to perform a connection management corresponding to the second RAT. The second terminal device may perform a connection management with the first terminal device according to a situation of RATs supported by itself. When the second terminal device also supports connection management corresponding to the first RAT, the second terminal device may establish a connection management corresponding to the first RAT with the first terminal device according to the first message.

When the first terminal device carries information of the first RAT and the second RAT in the first message, it may indicate that the first terminal device wants to perform a connection management corresponding to the first RAT and the second RAT. The second terminal device may perform a connection management with the first terminal device according to a situation of RATs supported by itself. When the second terminal device only supports a connection management corresponding to the first RAT, the second terminal device may establish a connection management corresponding to the first RAT with the first terminal device. When the second terminal device only supports a connection management corresponding to the second RAT, the second terminal device may alternatively establish a connection management corresponding to the second RAT with the first terminal device. When the second terminal device supports connection managements corresponding to the first RAT and the second RAT at the same time, the second terminal device may establish connection managements corresponding to the first RAT and the second RAT, respectively.

The information of the at least one RAT may be, for example, information of the first RAT and/or information of the second RAT.

The information of the first RAT may be, for example, at least one capability of the first terminal device to support a communication based on the first RAT, or may be at least one capability of the second terminal device about supporting a communication based on the first RAT asked by the first terminal device.

The ability of the first terminal device to support the communication based on the first RAT may be, for example, functions of the first terminal device for supporting multiple protocol layers in the first RAT. The second terminal device may determine the RAT for performing the connection management requested by the first terminal device according to the functions of the first terminal device for supporting multiple protocol layers.

Or, the ability of the first terminal device to support a communication based on the first RAT may be a frequency band used by the first terminal device to perform a communication based on the first RAT. The second terminal device may determine the RAT for performing the connection management requested by the first terminal device according to a frequency band supported by the first terminal device.

The at least one capability of the second terminal device about supporting a communication based on the first RAT asked by the first terminal device may be a function of the second terminal device about whether it supports multiple protocol layer, or a function of the second terminal device about whether it supports communication based on the frequency band used by the first RAT, asked by the first terminal device.

When the first terminal device asks the second terminal device about at least one capability of supporting a communication based on the first RAT, it may indicate that the first terminal device has a capability of supporting a communication based on the first RAT. If the second terminal device also has the ability to support a communication based on the first RAT, the second terminal device may establish a connection management with the first terminal device corresponding to the first RAT.

The information of the second RAT may be, for example, at least one ability of the first terminal device to support a communication based on the second RAT, or at least one ability of the second terminal device about supporting a communication based on the second RAT asked by the first terminal device. Detailed content may be referred to above description, which will not be repeated here to avoid a redundancy.

The first terminal device may indicate the RAT for requesting to perform a connection management in an implicit manner.

For example, the first terminal device indicates the RAT supported by the first terminal device in the first message. After receiving the first message, the second terminal device may determine the RAT supported by the first terminal device as a RAT for performing a connection management requested by the first terminal device.

When the RAT supported by the first terminal device is the first RAT, the second terminal device may default that the first terminal device wants to establish a connection management corresponding to the first RAT.

When the RAT supported by the first terminal device is the second RAT, the second terminal device may default that the first terminal device wants to establish a connection management corresponding to the second RAT.

When the first terminal device supports both the first RAT and the second RAT, the second terminal device may default that the first terminal device wants to establish connection managements corresponding to the first RAT and the second RAT, or the second terminal device may default that the first terminal device wants to establish a connection management corresponding to any one of the RATs.

For another example, the RAT for performing a connection management requested by the first terminal device may be implicitly indicated by a RAT used by the first terminal device to send the first message.

When the first terminal device sends the first message with the first RAT, it may implicitly indicate that the first terminal device wants to establish a connection management corresponding to the first RAT. When the second terminal device receives the first message with the first RAT, it may be determined that the first terminal device wants to perform a connection management corresponding to the first RAT.

When the first terminal device sends the first message with the second RAT, it may implicitly indicate that the first terminal device wants to establish a connection management corresponding to the second RAT. When the second terminal device receives the first message with the second RAT, it may be determined that the first terminal device wants to perform a connection management corresponding to the second RAT.

When the first terminal device sends the first message with both the first RAT and the second RAT, it may implicitly indicate that the first terminal device wants to establish a connection management corresponding to the first RAT and a connection management corresponding to the second RAT, or it may implicitly indicate that the first terminal device wants to establish a connection management corresponding to any one RAT. When the second terminal device receives the first message on both the first RAT and the second RAT, it may be determined that the first terminal device wants to perform connection managements corresponding to the first RAT and the second RAT, or it may be determined that the first terminal device wants to establish a connection management corresponding to any one RAT.

Optionally, the requests of the first terminal device to establish a connection management corresponding to different RATs may be carried by different messages.

The first terminal device may send a first message to request to establish a connection management corresponding to the first RAT and a second message to request to establish a connection management corresponding to the second RAT.

Or, the first terminal device may send a message to request to establish connection managements corresponding to multiple RATs.

For example, the first terminal device may send a first message to request to establish a connection management corresponding to the first RAT and a connection management corresponding to the second RAT.

It should be noted that the second terminal device may determine the RAT for performing a connection management requested by the first terminal device according to any one of the above-described ways, or according to any combination of the above-described ways, which is not specifically limited by implementations of the present disclosure.

As an example, the first terminal device may determine the RAT for performing a connection management requested by the first terminal device according to the RAT used by the first terminal device to send the first message and the RAT supported by the first terminal device. When the first message is transmitted with the first RAT, and the first message indicates that the first terminal device supports a connection management based on the second RAT, the second terminal device may determine that the first terminal device wants to establish connection managements corresponding to the first RAT and the second RAT.

Optionally, before sending the first message, the first terminal device may determine the RAT for requesting to perform a connection management according to supported RAT, and indicate the RAT for requesting to perform a connection management to the second terminal device through the first message.

In implementations of the present disclosure, the first terminal device may establish connection managements corresponding to multiple RATs by sending a message, which may save signaling overhead.

Optionally, the first message sent by the first terminal device may be used for indicating the RAT supported by the first terminal device. For example, the RAT supported by the first terminal device may be the first RAT and/or the second RAT.

There are many ways for the first terminal device to indicate the RAT supported by the first terminal device through the first message. The first terminal device may directly carry the information of the supported RAT in the first message, or the first terminal device may implicitly indicate the supported RAT through other information.

For example, the first message sent by the first terminal device to the second terminal device may include information of at least one RAT, wherein the information of at least one RAT is used for indicating the RAT supported by the first terminal device.

When information of the first RAT is included in the first message, it may indicate that the first terminal device supports the connection management based on the first RAT.

When information of the second RAT is included in the first message, it may indicate that the first terminal device supports the connection management based on the second RAT.

When the first message includes the information of the first RAT and the information of the second RAT, it may indicate that the first terminal device supports the connection management based on the first RAT and the second RAT.

The information of the at least one RAT may include the information of the first RAT and/or information of the second RAT. Specific contents of the information of the first RAT and the information of the second RAT may be referred to above description, which is not repeated here to avoid redundancy.

The first terminal device may also indicate the RAT supported by the first terminal device in an implicit manner.

For example, when the first terminal device sends the first message with the first RAT, it may implicitly indicate that the RAT supported by the first terminal device includes the first RAT.

When the first terminal device sends the first message with the second RAT, it may implicitly indicate that the RAT supported by the first terminal includes the second RAT.

When the first terminal device sends the first message with both the first RAT and the second RAT, it may implicitly indicate that the RATs supported by the first terminal device include the first RAT and the second RAT.

Optionally, if the RAT for performing the connection management requested by the first terminal device is indicated in the first message, which may alternatively implicitly indicate the RAT supported by the first terminal device. When the first message indicates that the first terminal device wants to establish a connection management corresponding to the first RAT, it may implicitly indicate that the RAT supported by the first terminal device includes the first RAT.

When the first message indicates that the first terminal device wants to establish a connection management corresponding to the second RAT, it may implicitly indicate that the RAT supported by the first terminal device includes the second RAT.

When the first message indicates that the first terminal device wants to establish a connection management corresponding to the first RAT and the second RAT, it may implicitly indicate that the RATs supported by the first terminal device include the first RAT and the second RAT.

It should be noted that the second terminal device may determine the RAT supported by the first terminal device to perform the connection management according to any one of above-described ways, or according to any combination of the above-described ways, which is not specifically limited by the implementations of the present disclosure.

As an example, the second terminal device may determine the RAT supported by the first terminal device according to the RAT for performing the connection management requested by the first terminal device and the RAT used by the first terminal device to send the first message. When the first message is transmitted based on the first RAT, and the first message indicates that the first terminal device wants to establish the connection management corresponding to the second RAT, the second terminal device may determine that the first terminal device supports the connection management corresponding to the first RAT and the second RAT.

It should be noted that the RAT used by the first terminal device to send the first message may be understood as the RAT used by the second terminal device to receive the first message.

In implementations of the application, a message may be used to indicate a condition of multiple RATs supported by the first terminal device, which may save signaling overhead.

Optionally, the RAT used by the first terminal device to send the first message may be the first RAT and/or the second RAT. That is, the first terminal device may send the first message based on the first RAT, based on the second RAT, or based on both the first RAT and the second RAT.

When at least one RAT indicated by the first message is the first RAT, the first terminal device may choose to send the first message based on the first RAT, based on the second RAT, or based on both the first RAT and the second RAT.

In this way, the first terminal device may not be restricted to sending the first message only on the first RAT, but may choose to send the first message on the second RAT when the first RAT has no idle resources, which may improve a flexibility of the communication.

Similarly, when at least one RAT indicated by the first message is the second RAT, the first terminal device may choose to send the first message based on the first RAT, based on the second RAT, or based on both the first RAT and the second RAT.

When at least one RAT indicated by the first message is the first RAT and the second RAT, the first terminal device may choose to send the first message based on the first RAT, based on the second RAT, or based on both the first RAT and the second RAT.

When the first terminal device sends the first message based on both the first RAT and the second RAT, contents contained in the first message may be the same or different.

Determining, by the first terminal device, the RAT used to send the first message may be determining, by the first terminal device, the RAT used to send the first message according to the first indication information. The first indication information may be preconfigured by the terminal device, or may be indicated to the terminal device by the network device through higher layer signaling.

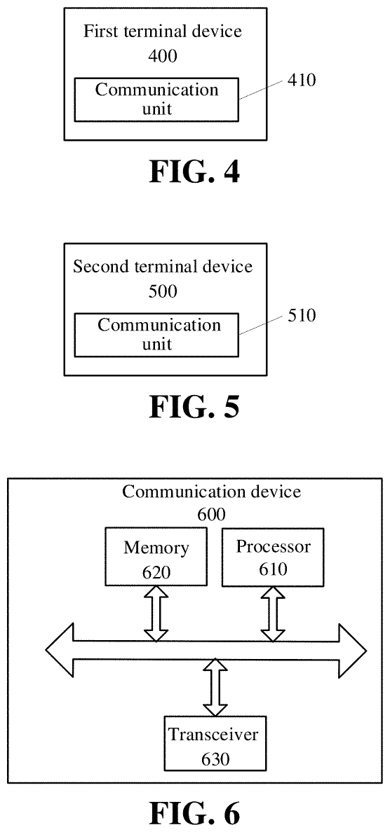

The wireless communication methods provided in implementations of the present invention has been described in detail above. A device provided in an implementation of the present invention will be described below with reference to FIG. 4 to FIG. 8. Technical features described in method implementations are applicable to following device implementations.

FIG. 4 is a schematic block diagram of a first terminal device provided by an implementation of the present disclosure. As shown in FIG. 4, the terminal device 400 includes a communication unit 410.

The communication unit 410 is configured to send a first message to a second terminal device, wherein the first message is used for indicating at least one radio access technology (RAT), and the at least one RAT is a RAT for performing a connection management requested by the first terminal device and/or a RAT supported by the first terminal device.

Optionally, the connection management includes any one of following: a connection establishment, a connection keep-alive, a connection reconfiguration and a connection release.

Optionally, the at least one RAT is indicated by a RAT used by the first terminal device to send the first message.

Optionally, the at least one RAT is indicated by information of the at least one RAT contained in the first message.

Optionally, the first message includes information of a first RAT, and the at least one RAT is the first RAT. Or the first message includes information of a second RAT, and the at least one RAT is the second RAT. Or the first message includes the information of a first RAT and the information of the second RAT, and the at least one RAT is the first RAT and the second RAT.

Optionally, the information of at least one RAT includes information of a first RAT and/or information of a second RAT. The information of the first RAT includes at least one ability of the first terminal device about supporting a communication based on the first RAT, and/or at least one ability of the second terminal device about supporting a communication based on the first RAT asked by first terminal device. The information of the second RAT includes at least one capability of the first terminal device about supporting a communication based on the second RAT, and/or at least one capability of the second terminal device about supporting a communication based on the second RAT asked by the first terminal device.

FIG. 5 is a schematic block diagram of a second terminal device provided by an implementation of the present disclosure. As shown in FIG. 5, the terminal device 500 includes a communication unit 510.

The communication unit 510 is configured to receive a first message sent by a first terminal device, wherein the first message is used to indicate at least one radio access technology (RAT), and the at least one RAT is a RAT for performing a connection management requested by the first terminal device and/or a RAT supported by the first terminal device.

Optionally, the connection management includes any one of the following: a connection establishment, a connection keep-alive, a connection reconfiguration and a connection release.

Optionally, the at least one RAT is indicated by a RAT used by the first terminal device to send the first message.

Optionally, the at least one RAT is indicated by information of at least one RAT contained in the first message.

Optionally, the first message includes information of a first RAT, and the at least one RAT is the first RAT. Or the first message includes information of a second RAT, and the at least one RAT is the second RAT. Or the first message includes information of the first RAT and information of the second RAT and the at least one RAT is the first RAT and the second RAT.

Optionally, the information of at least one RAT includes information of the first RAT and/or information of the second RAT. The information of the first RAT includes at least one ability of the first terminal device to support a communication based on the first RAT, and/or at least one ability of the second terminal device about supporting a communication based on the first RAT asked by the first terminal device. The information of the second RAT includes at least one capability of the first terminal device to support a communication based on the second RAT, and/or at least one capability of the second terminal device about supporting a communication based on the second RAT asked by the first terminal device.

Optionally, the at least one RAT is a RAT for performing a connection management requested by the first terminal device. The second terminal device further includes a processing unit, wherein the processing unit is configured to determine the RAT for performing the connection management requested by the first terminal device as a RAT supported by the first terminal device.

Optionally, the at least one RAT is a RAT supported by the first terminal device. The second terminal device further comprises a processing unit, wherein the processing unit is configured to determine the RAT supported by the first terminal device as a RAT that the first terminal device uses to request to perform the connection management.

Optionally, the at least one RAT is the first RAT, wherein the first RAT is a RAT for performing the connection management requested by the first terminal device. The communication unit is further configured to receive a second message sent by the first terminal device, wherein the second message is used for indicating that the RAT used by the first terminal device to request to perform the connection management is a second RAT.

Optionally, the at least one RAT is the first RAT, and the RAT used by the second terminal device to receive the first message is the first RAT and/or the second RAT. Or the at least one RAT is the first RAT, and the RAT used by the second terminal device to receive the first message is the first RAT and/or the second RAT. Or the at least one RAT is the first RAT and the second RAT, and the RAT used by the second terminal device to receive the first message is the first RAT and/or the second RAT.

FIG. 6 is a schematic structural diagram of a communication device 600 provided by an implementation of the present disclosure. A communication device 600 as shown in FIG. 6 includes a processor 610. The processor 610 may call and run a computer program from a memory to implement a method in an implementation of the present disclosure.

Optionally, as shown in FIG. 6, the communication device 600 may further include a memory 620. The processor 610 may call and run a computer program from the memory 620 to implement the method in implementations of the present disclosure.

The memory 620 may be a separate device independent of the processor 610 or may be integrated in the processor 610.

Optionally, as shown in FIG. 6, the communication device 600 may further include a transceiver 630, and the processor 610 may control the transceiver 630 to communicate with other devices. Specifically, the transceiver 630 may send information or data to other devices or receive information or data sent by other devices.

The transceiver 630 may include a transmitter and a receiver. The transceiver 630 may further include antennas, and a number of antennas may be one or more.

Optionally, the communication device 600 may be specifically a network device in implementations of the present disclosure, and the communication device 600 may implement corresponding processes implemented by the network device in various methods in implementations of the present disclosure, which will not be repeated here for brevity.

Optionally, the communication device 600 may be specifically a terminal device in implementations of the present disclosure, and the communication device 600 may implement corresponding processes implemented by the terminal device in various methods in implementations of the present disclosure, which will not be repeated here for brevity.

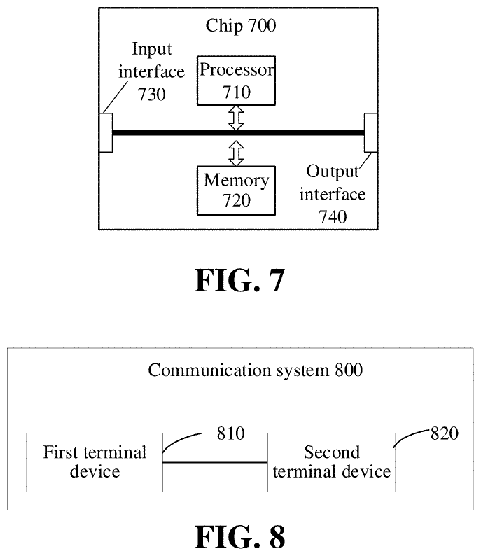

FIG. 7 is a schematic structural diagram of a chip of an implementation of the present disclosure. A chip 700 shown in FIG. 7 includes a processor 710. The processor 710 may call and run a computer program from a memory to implement methods in implementations of the present disclosure.

Optionally, as shown in FIG. 7, the chip 700 may further include a memory 720. The processor 710 may call and run a computer program from the memory 720 to implement the methods in implementations of the present disclosure.

The memory 720 may be a separate device independent of the processor 710 or may be integrated in the processor 710.

Optionally, the chip 700 may further include an input interface 730. The processor 710 may control the input interface 730 to communicate with other devices or chips. Specifically, the input interface 730 may obtain information or data sent by other devices or chips.

Optionally, the chip 700 may further include an output interface 740. The processor 710 may control the output interface 740 to communicate with other devices or chips. Specifically, the output interface 740 may output information or data to other devices or chips.

Optionally, the chip may be applied in a terminal device in implementations of the present disclosure, and the chip may implement corresponding processes implemented by the terminal device in various methods in implementations of the present disclosure, which will not be repeated here for brevity.

Optionally, the chip may be applied in a network device in implementations of the present disclosure, and the chip may implement corresponding processes implemented by the network device in various methods in implementations of the present disclosure, which will not be repeated here for brevity.

It should be understood that the chip mentioned in implementations of the present disclosure may be referred to as a system-level chip, a system chip, a chip system or a system-on-chip, etc.

It should be understood that, the processor in implementations of the present disclosure may be an integrated circuit chip having a signal processing capability. In an implementation process, each step of above method implementations may be implemented by using an integrated logic circuit of hardware in the processor or instructions in a form of software. Above processor may be a general purpose processor, a Digital Signal Processing (DSP), an Application Specific Integrated Circuit (ASIC), a Field Programmable Gate Array (FPGA) or other programmable logic devices, a discrete gate or a transistor logic device, or a discrete hardware component. The processor may implement or execute various methods, steps and logical block diagrams disclosed in implementations of the present disclosure. The general purpose processor may be a microprocessor, or the processor may be any conventional processor, etc. Steps of methods disclosed with reference to implementations of the present disclosure may be directly implemented by a hardware decoding processor, or may be implemented by a combination of hardware and software modules in the decoding processor. The software modules may be located in a storage medium commonly used in the art, such as a random access memory, a flash memory, a read-only memory, a programmable read-only memory or an electrically erasable programmable memory, or a register. The storage medium is located in the memory, and the processor reads the information in the memory and completes steps of the above method in combination with its hardware.

It may be understood that, the memory in implementations of the present disclosure may be a volatile memory or a non-volatile memory, or may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), and is used as an external cache. Through exemplary but not limitative description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It should be noted that the memory in the systems and methods described in this specification is aimed at including but being not limited to these and any memory of another proper type.

It should be understood that, the foregoing memory is an example for illustration and should not be construed as limiting. For example, optionally, the memory in implementations of the present disclosure may be a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), a Direct Rambus RAM (DR RAM), or the like. That is, memories in implementations of the present disclosure are intended to include, but are not limited to, these and any other suitable types of memories.

FIG. 8 is a schematic block diagram of a communication system 800 provided by an implementation of the present disclosure. As shown in FIG. 8, the communication system 800 includes a first terminal device 810 and a second terminal device 820.

The terminal device 810 may be configured to implement corresponding functions implemented by the first terminal device in above-mentioned method, and the second terminal device 820 may be configured to implement corresponding functions implemented by the second terminal device in the above-mentioned method, which will not be repeated here for brevity.

An implementation of the present disclosure further provides a computer readable storage medium configured to store a computer program.

Optionally, the computer readable storage medium may be applied in a terminal device of implementations of the present disclosure, and the computer program enables the computer to perform the corresponding procedures implemented by the terminal device in various methods of implementations of the present disclosure.

An implementation of the present disclosure also provides a computer program product including computer program instructions.

Optionally, the computer program product may be applied in a terminal device of implementations of the present disclosure, and the computer program instructions cause the computer to execute corresponding procedures implemented by the terminal device in various methods according to implementations of the present disclosure.

An implementation of the present disclosure also provides a computer program.

Optionally, the computer program may be applied in a terminal device of implementations of the present disclosure. When the computer program is run on the computer, the computer is caused to execute corresponding processes implemented by the terminal device in various methods of implementations of the present disclosure.

Those of ordinary skill in the art will recognize that the exemplary elements and algorithm steps described in combination with implementations disclosed herein may be implemented in electronic hardware, or a combination of computer software and electronic hardware. Whether these functions are implemented in hardware or software depends on the specific application and design constraints of the technical solution. Skilled artisans may use different methods to implement the described functions in respect to each particular application, but such implementation should not be considered to be beyond the scope of the present disclosure.

Those skilled in the art may clearly understand that for convenience and conciseness of description, the specific working processes of the systems, apparatuses and units described above may refer to the corresponding processes in the method implementations and will not be described here.

In several implementations provided by the present disclosure, it should be understood that the disclosed systems, apparatuses and methods may be implemented in other ways. For example, the apparatus implementations described above are only illustrative, for example, the division of the units is only a logical function division, and there may be other division manners in actual implementation, for example, multiple units or components may be combined or integrated into another system, or some features may be ignored or not executed. On the other hand, the mutual coupling or direct coupling or communication connection shown or discussed may be indirect coupling or communication connection through some interface, apparatus or unit, and may be in electrical, mechanical or other forms.

The unit described as a separate component may or may not be physically separated, and the component shown as a unit may or may not be a physical unit, i.e., it may be located in one place or may be distributed over multiple network units. Some or all of the units may be selected according to actual needs to achieve the purpose of implementations.

In addition, various functional units in various implementations of the present disclosure may be integrated in one processing unit, or the various units may be physically present separately, or two or more units may be integrated in one unit.

The functions may be stored in a computer readable storage medium if realized in a form of software functional units and sold or used as a separate product. Based on this understanding, the technical solution of the present disclosure, in essence, or the part contributing to the prior art, or the part of the technical solution, may be embodied in the form of a software product stored in a storage medium, including a number of instructions for causing a computer device (which may be a personal computer, a server, or a network device and the like) to perform all or part of the steps of the method described in various implementations of the present disclosure. The foregoing storage medium includes: any medium that may store program code, such as a USB flash drive, a removable hard disk, a Read-Only Memory (ROM), a Random Access Memory (RAM), a magnetic disk, or an optical disc.

What are described above are merely exemplary implementations of the present disclosure, but a protection scope of the present disclosure is not limited thereto. Any variation or substitution that may be easily conceived by a person skilled in the art within the technical scope disclosed by the present disclosure shall be included within the protection scope of the present disclosure. Therefore, the protection scope of the present disclosure shall be determined by a protection scope of claims.

What is claimed is:

1. A method for wireless communication, comprising:
sending, by a first terminal device, a first message to a second terminal device, wherein the first message is used for indicating at least one radio access technology (RAT), and the at least one RAT is a RAT for performing a connection management requested by the first terminal device and/or a RAT supported by the first terminal device.

2. The method of claim 1, wherein the connection management comprises any one of following: a connection establishment, a connection keep-alive, a connection reconfiguration, or a connection release.

3. The method of claim 1, wherein the at least one RAT is indicated by a RAT used by the first terminal device to send the first message.

4. The method of claim 1, wherein the at least one RAT is indicated by information of the at least one RAT contained in the first message.

5. The method of claim 4, wherein the first message comprises information of a first RAT, and the at least one RAT is the first RAT,
or, the first message comprises information of a second RAT, and the at least one RAT is the second RAT,
or, the first message comprises information of a first RAT and information of a second RAT, and the at least one RAT is the first RAT and the second RAT.

6. The method of claim 4, wherein the information of the at least one RAT comprises information of a first RAT and/or information of a second RAT,
the information of the first RAT comprises at least one capability of the first terminal device to support a communication based on the first RAT, and/or at least one capability of the second terminal device about supporting a communication based on the first RAT asked by the first terminal device, and
the information of the second RAT comprises at least one capability of the first terminal device to support a communication based on the second RAT, and/or at least one capability of the second terminal device about supporting a communication based on the second RAT asked by the first terminal device.

7. The method of claim 1, wherein the at least one RAT is the RAT for performing the connection management requested by the first terminal device, and the method further comprises:
before sending, by the first terminal device, the first message to the second terminal device, determining, by the first terminal device, the at least one RAT according to supported RATs.

8. The method of claim 1, wherein the at least one RAT is a first RAT, and the first RAT is the RAT for performing the connection management requested by the first terminal device, and the method further comprises:
sending, by the first terminal device, a second message to the second terminal device, wherein the second message is used for indicating that the RAT for performing the connection management requested by the first terminal device is a second RAT.

9. The method of claim 1, wherein the at least one RAT is a first RAT, a RAT used by the first terminal device to send the first message is the first RAT and/or a second RAT,
or, the at least one RAT is a first RAT, and a RAT used by the first terminal device to send the first message is a first RAT and/or the second RAT,
or, the at least one RAT is a first RAT and a second RAT, and a RAT used by the first terminal device to send the first message is the first RAT and/or the second RAT.

10. A first terminal device, comprising: a processor, a transceiver and a memory, wherein the memory is configured to store a computer program, the transceiver is configured to communicate with other devices under control of the processor, and the processor is configured to call and run the computer program stored in the memory to:
send a first message to a second terminal device, wherein the first message is used for indicating at least one radio access technology (RAT), and the at least one RAT is a RAT for performing a connection management requested by the first terminal device and/or a RAT supported by the first terminal device.

11. The first terminal device of claim 10, wherein the connection management comprises any one of following: a connection establishment, a connection keep-alive, a connection reconfiguration, or a connection release.

12. The first terminal device of claim 10, wherein the at least one RAT is indicated by a RAT used by the first terminal device to send the first message.

13. The first terminal device of claim 10, wherein the at least one RAT is indicated by information of the at least one RAT contained in the first message.

14. The first terminal device of claim 13, wherein the first message comprises information of a first RAT, and the at least one RAT is the first RAT,
or, the first message comprises information of a second RAT, and the at least one RAT is the second RAT,
or, the first message comprises information of a first RAT and information of a second RAT, and the at least one RAT is the first RAT and the second RAT.

15. The first terminal device of claim 13, wherein information of the at least one RAT comprises information of a first RAT and/or information of a second RAT,
the information of the first RAT comprises at least one capability of the first terminal device to support a communication based on the first RAT, and/or at least one capability of the second terminal device about supporting a communication based on the first RAT asked by the first terminal device, and
the information of the second RAT comprises at least one capability of the first terminal device to support communication based on the second RAT, and/or at least one capability of the second terminal device about supporting a communication based on the second RAT asked by the first terminal device.

16. The first terminal device of claim 10, wherein the at least one RAT is a RAT for performing the connection management requested by the first terminal device, and the processor is configured to:
determine the at least one RAT according to supported RAT.

17. The first terminal device of claim 10, wherein the at least one RAT is a first RAT, the first RAT is a RAT for performing the connection management requested by the first terminal device, and
the processor is configured to send a second message to the second terminal device, and the second message is used for indicating that the RAT for performing the connection management requested by the first terminal device is a second RAT.

18. The first terminal device of claim 10, wherein the at least one RAT is a first RAT, a RAT used by the first terminal device to send the first message is the first RAT and/or a second RAT,
or, the at least one RAT is a first RAT, and a RAT used by the first terminal device to send the first message is a first RAT and/or the second RAT,
or, the at least one RAT is a first RAT and a second RAT, and a RAT used by the first terminal device to send the first message is the first RAT and/or the second RAT.

19. The first terminal device of claim 10, wherein a RAT used by the first terminal device to send the first message is determined according to first indication information, wherein the first indication information is preconfigured by the first terminal device or obtained by higher layer signaling.

20. A non-transitory computer readable storage medium, configured to store a computer program, wherein the computer program causes a computer to:
send a first message to a second terminal device, wherein the first message is used for indicating at least one radio access technology (RAT), and the at least one RAT is a RAT for performing a connection management requested by the first terminal device and/or a RAT supported by the first terminal device.
